(19) United States
(12) Patent Application Publication
(10) Pub. No.: US 2022/0084491 A1
(43) Pub. Date: Mar. 17, 2022

(54) CONTROL DEVICE, ELECTRONIC MUSICAL INSTRUMENT SYSTEM, AND CONTROL METHOD

(71) Applicant: Roland Corporation, Shizuoka (JP)

(72) Inventors: Hiromi TORIKURA, Shizuoka (JP); Takuma YAMASHITA, Shizuoka (JP); Takeshi TOJO, Shizuoka (JP)

(73) Assignee: Roland Corporation, Shizuoka (JP)

(21) Appl. No.: 17/418,245

(22) PCT Filed: Dec. 28, 2018
(86) PCT No.: PCT/JP2018/048555

§ 371 Date: Jun. 25, 2021

(51) Int. Cl. G10H 5/00; G10H 1/00; G10L 15/22; G10L 15/18

(52) U.S. Cl. CPC G10H 5/005; G10H 1/0075; G10L 15/22; G10L 2015/228; G10L 2015/223; G10L 2015/225; G10L 2015/227; G10L 15/1822

(57) ABSTRACT

Provided is a control device which controls an electronic musical instrument, comprising: an acquisition means which understands the intention of an utterance of a user on the basis of the utterance, and acquires from a dialogue engine that generates first data in which the intention is stated, the first data generated in response to the utterance; a storage means which stores conversion data in which the first data and a control command for controlling the electronic musical instrument are associated with each other; and a conversion means which generates, on the basis of the acquired first data and the conversion data, second data suitable for a control interface of the electronic musical instrument to be controlled, and transmits the second data to the electronic musical instrument.

### TECHNICAL FIELD

The disclosure relates to control of an electronic musical instrument.

### BACKGROUND ART

In the field of music, systems that can control the musical sound of an electronic musical instrument without directly touching the electronic musical instrument have been devised. For example, an electronic musical instrument that identifies a command input as vocal sound via a microphone during a performance and controls the musical sound on the basis of the identified command is disclosed in Patent Literature 1.

### CITATION LIST

### Patent Literature

### [Patent Literature 1]

Japanese Patent Laid-Open No. H10-301567

### SUMMARY

### Technical Problem

The electronic musical instrument described in Patent Literature 1 identifies a command which is input as vocal sound by referring to a built-in voice recognition dictionary. However, it is not easy to add a voice recognition function to an existing electronic musical instrument.

The disclosure was contrived in consideration of the aforementioned circumstances and an objective thereof is to provide a control device that can enable an existing electronic musical instrument to cope with control based on vocal sound.

### Solution to Problem

In order to achieve the objective, a control device according to the disclosure is a control device that controls an electronic musical instrument, the control device including: an acquisition means that acquires first data which is generated in response to an utterance of a user from a dialogue engine which understands an intention of the utterance on a basis of the utterance and generates the first data in which the intention is stated; a storage means that stores conversion data which is data in which the first data is correlated with a control command for controlling the electronic musical instrument; and a conversion means that generates second data which is suitable for a control interface of the electronic musical instrument to be controlled on a basis of the first data that has been acquired and the conversion data and transmits the second data to the electronic musical instrument.

The dialogue engine is a device that understands an intention of an utterance of a user on the basis of the utterance. The dialogue engine may be, for example, a server device (which is also referred to as an AI server, an assistant server, or the like) that provides an arbitrary service in cooperation with a smart speaker. The dialogue engine generates first data in which the intention is stated on the basis of the utterance of the user. The first data may have any format as long as the control device can analyze it.

The second data is data which is suitable for an interface such as an MIDI (registered trademark) in the electronic musical instrument. The control device converts the first data which is generated with an utterance of a user as a trigger and the second data on the basis of the conversion data. With this configuration, it is possible to enable an electronic musical instrument not including a voice interface to easily cope with control based on vocal sound.

The conversion means may generate the second data including one of a command for changing a parameter set in the electronic musical instrument to be controlled and a command for reading the parameter that has been set on a basis of the first data.

Commands for an electronic musical instrument are roughly classified into commands for changing parameters of the electronic musical instrument and commands for reading set parameters. It is preferable that the control device discern the commands on the basis of the first data and generate the second data including an appropriate command.

The conversion means may acquire a response from the electronic musical instrument in response to the second data, convert the response to third data for causing the dialogue engine to generate a response utterance, and transmit the third data to the dialogue engine.

When the dialogue engine can generate a response utterance, the dialogue engine can respond to an utterance of a user using vocal sound by converting a response from the electronic musical instrument and transmitting the converted response to the dialogue engine. For example, it is possible to notify of details of a parameter of the electronic musical instrument which is set in response to an utterance using vocal sound.

The storage means may store the conversion data for each of a plurality of electronic musical instruments, and the conversion means may select a corresponding conversion data when it is detected that one of the plurality of electronic musical instruments has been connected.

The conversion data may differ depending on a type of an electronic musical instrument. Therefore, it is possible to improve a user's convenience by storing a plurality of pieces of conversion data and automatically selecting conversion data to be used according to the connected electronic musical instrument.

The storage means may store a history of the parameters set in a past in the electronic musical instrument on a basis of the second data, and the conversion means may generate the second data for restoring the parameters with reference to the history when an intention indicating that the parameters set in the electronic musical instrument to be controlled are to be restored is stated in the first data that has been acquired.

The history corresponding to several generations may be stored. In this way, it is possible to improve a user's convenience by storing parameters set in the past and using the set parameters for a redoing (cancelling) operation.

An electronic musical instrument system according to the disclosure is an electronic musical instrument system including: an electronic musical instrument that includes a predetermined interface; a voice input means that transmits vocal sound uttered by a user to a dialogue engine which understands an intention of an utterance of the user on a basis of the utterance and generates first data in which the intention is stated; an acquisition means that acquires the first data generated in response to the utterance from the dialogue engine; a storage means that stores conversion data in which the first data is correlated with a control command for controlling the electronic musical instrument; and a conversion means that generates second data which is suitable for the predetermined interface on a basis of the first data that has been acquired and the conversion data and transmits the second data to the electronic musical instrument.

A control method according to the disclosure is a control method which is performed by a control device that controls an electronic musical instrument, the control method including: an acquisition step of acquiring first data which is generated in response to an utterance of a user from a dialogue engine which understands an intention of the utterance on a basis of the utterance and generates the first data in which the intention is stated; and a conversion step of generating second data which is suitable for a control interface of the electronic musical instrument to be controlled on a basis of conversion data which is data in which the first data is correlated with a control command for controlling the electronic musical instrument and the first data that has been acquire and transmits the second data to the electronic musical instrument.

A control method according to another aspect of the disclosure is a control method which is performed by a control device that controls an electronic musical instrument, the control method including: a step of acquiring and storing a parameter which is set in the electronic musical instrument when the electronic musical instrument has been connected; a step of acquiring an instruction for changing at least a parameter of the electronic musical instrument from a user; a step of generating a control command for changing the parameter that has been instructed on a basis of the instruction and transmitting the control command to the electronic musical instrument; and a step of updating the parameter that has been stored with a changed parameter.

The disclosure can be identified as a control device or an electronic musical instrument system including at least some of the aforementioned means. The disclosure may be identified as a control method which is performed by the control device or the electronic musical instrument system or a control program for performing the control method. The processes or the means described above can be freely combined for implementation unless technical confliction arises.

### BRIEF DESCRIPTION OF DRAWINGS

FIG. 1 is a diagram schematically illustrating an electronic musical instrument system according to a first embodiment.

FIG. 2 is a diagram illustrating a hardware configuration of a control device 10.

FIG. 3 is a diagram illustrating a hardware configuration of an electronic musical instrument 20.

FIG. 4 is a diagram illustrating a hardware configuration of a voice input and output device 40.

FIG. 5 is a diagram illustrating functional modules of a device constituting a system.

FIG. 6 is a diagram illustrating a data flow in the first embodiment.

FIGS. 7(A) and 7(B) are diagrams illustrating JSON data in the first embodiment.

FIG. 8 is a diagram illustrating conversion data in the first embodiment.

FIG. 9 is a diagram illustrating a data flow in a second embodiment.

FIG. 10 is a diagram illustrating a data flow in a third embodiment.

FIG. 11 is a diagram illustrating an example of conversion data and a parameter table in the third embodiment.

FIG. 12 is a diagram illustrating an example of conversion data and an undo table in a fourth embodiment.

FIGS. 13(A) and 13(B) are diagrams illustrating JSON data in the fourth embodiment.

FIG. 14 is a diagram illustrating functional modules in a modified example.

FIG. 15 is a diagram illustrating functional modules in a modified example.

### DESCRIPTION OF EMBODIMENTS

### First Embodiment

Hereinafter, an exemplary embodiment will be described with reference to the accompanying drawings. The following embodiment can be appropriately modified according to a configuration or various conditions of a system and the disclosure is not limited to the embodiment.

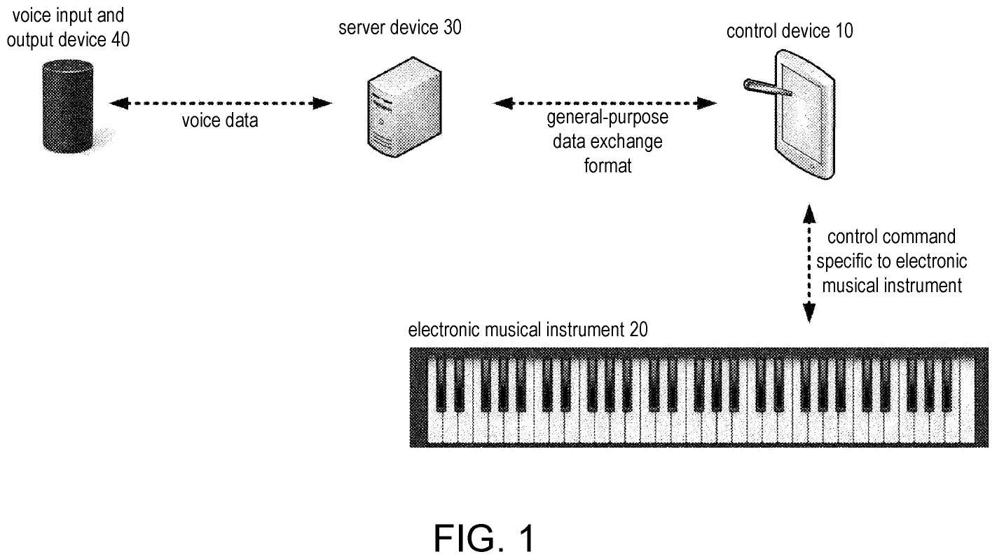

FIG. 1 is a diagram schematically illustrating an electronic musical instrument system according to this embodiment.

The electronic musical instrument system according to this embodiment includes a control device 10 that transmits and receives a control command to and from an electronic musical instrument 20, a server device 30 that takes charge of a voice interaction, and a voice input and output device 40.

The voice input and output device 40 is a device that receives an instruction for the electronic musical instrument 20, which has been uttered from a user, by vocal sound and transmits the received instruction to the server device 30. The voice input and output device 40 also has a function of reproducing voice data which is transmitted from the server device 30.

The server device 30 is a dialogue engine that understands content (an intention) of an utterance of a user on the basis of voice data transmitted from the voice input and output device 40, converts the utterance into a general-purpose data exchange format, and transmits the converted data to the control device 10. The server device 30 also has a function of generating voice data on the basis of data transmitted from the control device 10.

The control device 10 is a device that generates a control signal for controlling the electronic musical instrument 20 on the basis of data acquired from the server device 30 and transmits the control signal. As a result, parameters of musical sound which is output from the electronic musical instrument 20 can be changed or various effects can be added to the musical sound. The control device 10 also has a function of converting a response transmitted from the electronic musical instrument 20 into a format which can be analyzed by the server device 30. As a result, information acquired from the electronic musical instrument 20 can be provided to a user by vocal sound.

The control device 10 and the electronic musical instrument 20 are connected via a predetermined interface which is specialized for connection of an electronic musical instrument. The control device 10 and the server device 30 are connected via a network, and the server device 30 and the voice input and output device 40 are connected via a network.

The electronic musical instrument 20 is a synthesizer including a performance operator which is a keyboard instrument and a sound source. In this embodiment, the electronic musical instrument 20 generates musical sound based on a performance operation which is performed on the keyboard instrument and outputs the generated musical sound from a speaker which is not illustrated. The electronic musical instrument 20 changes parameters of musical sound on the basis of a control signal transmitted from the control device 10. In this embodiment, a synthesizer is exemplified as the electronic musical instrument 20, and another device may be employed. An object to be changed is not limited to parameters of musical sound.

For example, an object to be changed may be a reproduction tempo of a musical piece, a tempo of a metronome, selection of a musical piece, reproduction start or reproduction stop of a musical piece, start (note-on) and stop (note-off) of sound emission, control of a pitch bend, selection of a tone, or recording start or recording stop of performance. This change may be performed during performance (during emission of sound).

The electronic musical instrument 20 can return information on the basis of a control signal transmitted from the control device 10. For example, musical sound parameters, tempos, a title of a musical piece, instrument information (instrument information or the like), or the like which are currently set may be returned.

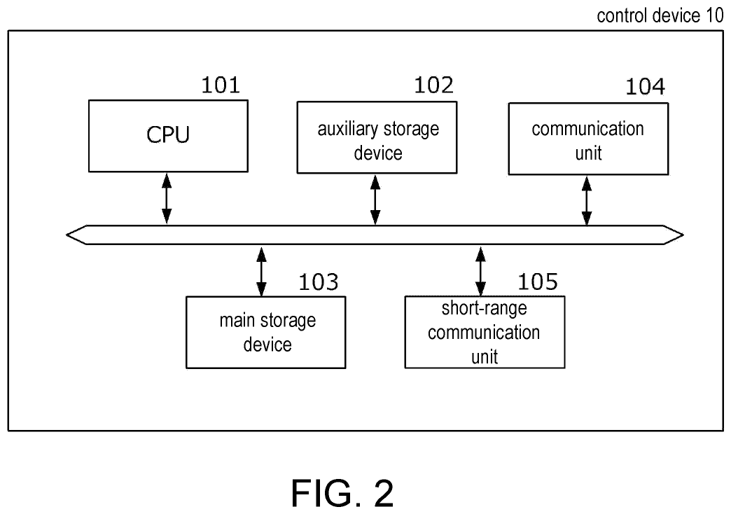

The configuration of the control device 10 will be described below. FIG. 2 is a diagram illustrating a hardware configuration of the control device 10.

The control device 10 is a small computer such as a smartphone, a mobile phone, a tablet computer, a personal information assistant, a notebook computer, or a wearable computer (such as a smart watch). The control device 10 includes a central processing unit (CPU) 101, an auxiliary storage device 102, a main storage device 103, a communication unit 104, and a short-range communication unit 105.

The CPU 201 is an arithmetic operation device that takes charge of control which is performed by the control device 10.

The auxiliary storage device 102 is a rewritable nonvolatile memory. A program which is executed by the CPU 101 or data which is used by the control program is stored in the auxiliary storage device 102. The auxiliary storage device 102 may store an application into which the program which is executed by the CPU 101 is packaged. The auxiliary storage device may store an operating system for executing such an application.

The main storage device 103 is a memory to which the program which is executed by the CPU 101 or the data which is used by the control program is loaded. The following processes are performed by loading the program stored in the auxiliary storage device 102 to the main storage device 103 and causing the CPU 101 to execute the program.

The communication unit 104 is a communication interface for transmitting and receiving data to and from the server device 30. The control device 10 and the server device 30 are communicatively connected to each other via a wide area network such as the Internet or a LAN. The network is not limited to a single network and any type of network may be used as long as data can be transmitted and received therethrough.

The short-range communication unit 105 is a radio communication interface that transmits and receives a signal to and from an electronic musical instrument 20. For example, Bluetooth (registered trademark) Low Energy (BLE) can be employed as a radio communication mode, but another mode may be employed. When BLE is used for connection with the electronic musical instrument 20, an MIDI over Bluetooth Low Energy (BLE-MIDI) standard may be used. In this embodiment, wireless connection is used for connection between the control device 10 and the electronic musical instrument 20, but wired connection may be used. In this case, the short-range communication unit 105 is replaced with a wired connection interface.

The configuration illustrated in FIG. 2 is an example and all or some of the illustrated functions may be realized by a dedicatedly designed circuit. Storage and execution of a program may be performed by a combination of a main storage device and an auxiliary storage device which is not illustrated.

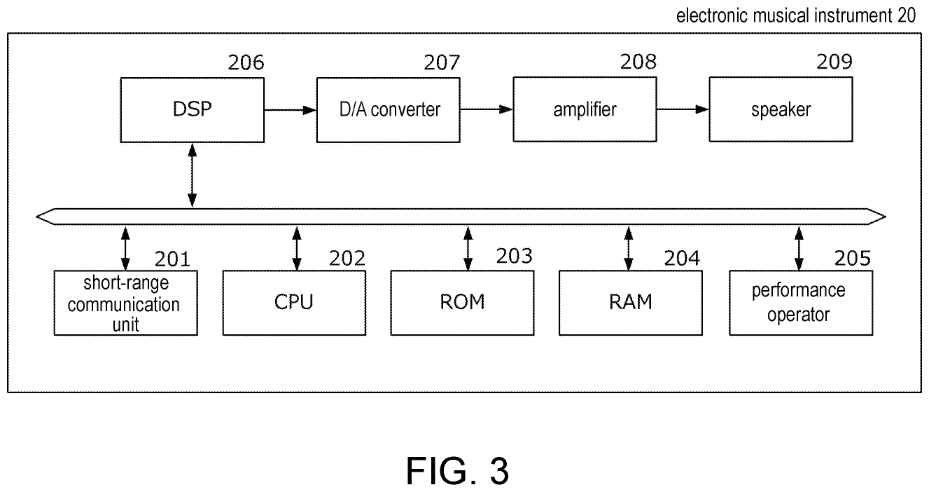

A hardware configuration of an electronic musical instrument 20 will be described below with reference to FIG. 3.

The electronic musical instrument 20 is a device that synthesizes musical sound on the basis of an operation which is performed on a performance operator (a keyboard instrument), and amplifies and outputs the synthesized musical sound. The electronic musical instrument 20 includes, a short-range communication unit 201, a CPU 202, a ROM 203, a RAM 204, a performance operator 205, a DSP 206, a D/A converter 207, an amplifier 208, and a speaker 209.

The short-range communication unit 201 is a radio communication interface that transmits and receives a signal to and from the control device 10. In this embodiment, the short-range communication unit 201 is wirelessly connected to the short-range communication unit 105 of the control device 10 and transmits and receives a message based on an MIDI standard. Details of data which is transmitted and received will be described later.

The CPU 202 is an arithmetic operation device that takes charge of control which is performed by the electronic musical instrument 20. Specifically, the CPU performs processes which are described in this specification, processes of synthesizing musical sound using the DSP 206 which will be described later on the basis of scanning or performed operations of the performance operator 205, and the like.

The ROM 203 is a rewritable nonvolatile memory. A control program which is executed by the CPU 202 or data which is used by the control program is stored in the ROM 203.

The RAM 204 is a memory to which the control program which his performed by the CPU 202 or data which is used by the control program is loaded. The processes which will be described later are performed by loading the program stored in the ROM 203 to the RAM 204 and causing the CPU 202 to execute the program.

The configuration illustrated in FIG. 3 is an example and all or some of the illustrated functions may be realized by a dedicatedly designed circuit. Storage and execution of a program may be performed by a combination of a main storage device and an auxiliary storage device which is not illustrated.

The performance operator 205 is an interface that receives a performance operation from a performer. In this embodiment, the performance operator 205 includes a keyboard instrument that is used for performance and an input interface (for example, a knob or a push button) that designates musical sound parameters or the like.

The DSP 206 is a microprocessor that is specialized for processing a digital signal. In this embodiment, the DSP 206 performs processes specialized for processing a voice signal under the control of the CPU 202. Specifically, the DSP performs synthesis of musical sound, addition of effects to musical sound, and the like on the basis of a performance operation and outputs a voice signal. The voice signal output from the DSP 206 is converted to an analog signal by the D/A converter 207, is amplified by the amplifier 208, and then is output from the speaker 209.

The server device 30 will be described below.

The server device 30 is, for example, a computer such as a personal computer, a workstation, a general-purpose server device, or a dedicated server device. The server device 30 includes a CPU, a main storage device, an auxiliary storage device, and a communication unit similarly to the control device 10. The hardware configuration is the same as that of the control device 10 except that a short-range communication unit is not provided and thus detailed description thereof will be omitted. In the following description, an arithmetic operation device of the server device 30 is referred to as a CPU 301.

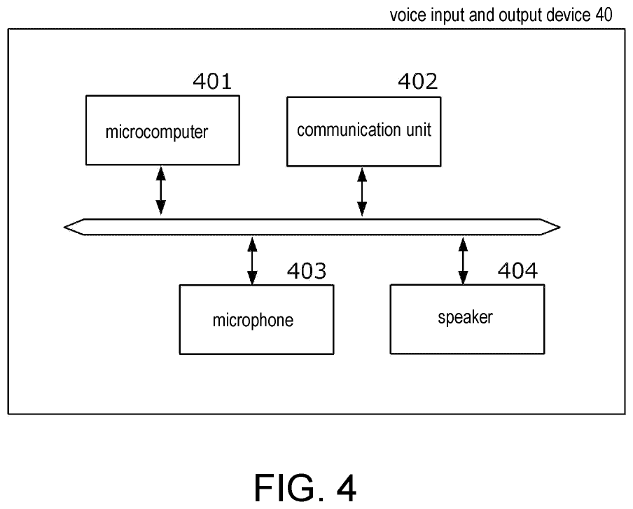

A hardware configuration of the voice input and output device 40 will be described below with reference to FIG. 4.

The voice input and output device 40 is a so-called smart speaker including a means that inputs and outputs vocal sound and a means that communicates with the server device 30. For example, an AmazonEcho (registered trademark) or a GoogleHome (registered trademark) can be used as the voice input and output device 40.

When a user utters vocal sound to the voice input and output device 40, the voice input and output device 40 communicates with a predetermined server device (the server device 30 in this embodiment) and the server device performs a process corresponding to the utterance. In the server device, a service for cooperating with the voice input and output device 40 is performed. The service (also referred to as a skill) can be desired by a third party or a user. In this embodiment it is assumed that a service for controlling an electronic musical instrument is performed by the server device 30.

The voice input and output device 40 includes a microcomputer 401, a communication unit 402, a microphone 403, and a speaker 404.

The microcomputer 401 is a one-chip microcomputer into which an arithmetic operation device, a main storage device, and an auxiliary storage device are packaged. The microcomputer 401 provides a front end process in response to vocal sound. Specifically, the microcomputer 401 performs a process of recognizing a position (a position relative to the device) of a user having uttered vocal sound, a process of separating voices uttered from a plurality of users, a process of setting directivity of the microphone 403 which will be described later on the basis of a position of a user, a noise reduction process, an echo cancellation process, a process of generating voice data which is transmitted to the server device 30, a process of reproducing voice data received from the server device 30, and the like.

The communication unit 402 is a communication interface that transmits and receives data to and from the server device 30. The voice input and output device 40 and the server device 30 are communicatively connected to each other via a wide area network such as the Internet or a LAN. The network is not limited to a single network and any type of network may be used as long as it can realize transmission and reception of data.

The microphone 403 and the speaker 404 are means that acquire vocal sound uttered by a user and provides vocal sound to a user.

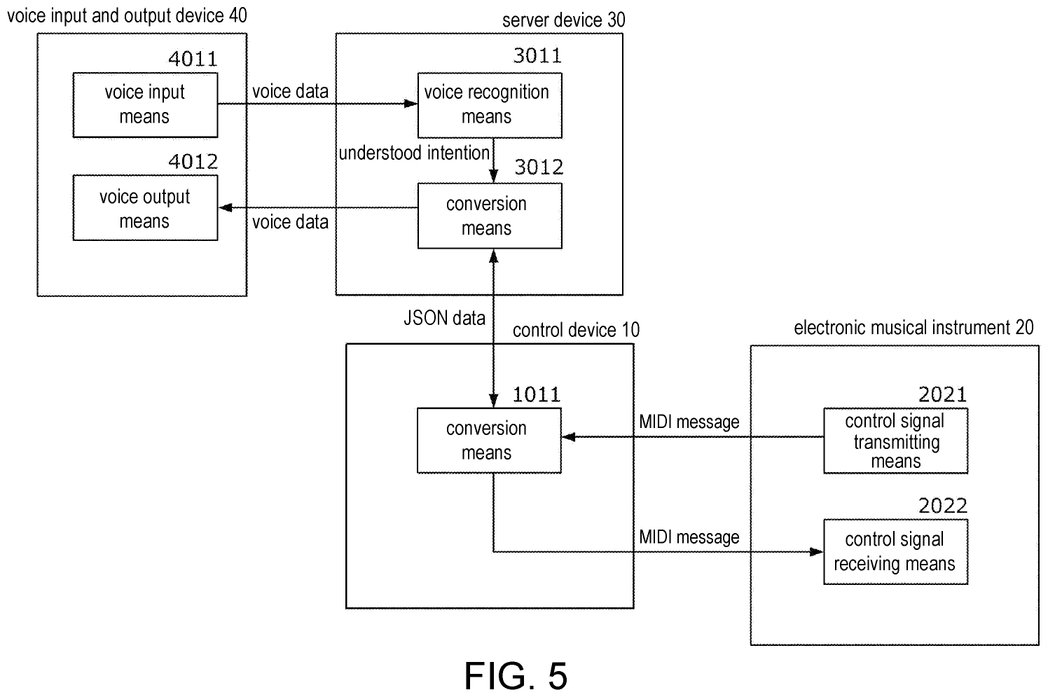

Functional blocks of the control device 10, the electronic musical instrument 20, the server device 30, and the voice input and output device 40 will be described below with reference to FIG. 5. The illustrated means are realized by arithmetic operation devices (the CPUs 101, 202, and 301 and the microcomputer 401) of the devices.

The functional blocks of the voice input and output device 40 will be first described below.

A voice input means 4011 of the voice input and output device 40 converts an electrical signal input from the microphone 403 to voice data and transmits the voice data to the server device 30 via the network.

A voice output means 4012 acquires voice data from the server device 30 and outputs the acquired voice data via the speaker 404.

The functional blocks of the server device 30 will be described below.

In the server device 30, a service for cooperating with the voice input and output device 40 is performed as described above. Specifically, the server device 30 recognizes vocal sound, understands, for example, an intention indicating “what” and “how,” and performs processing based on the understanding.

In this embodiment, the server device 30 provides data for controlling an electronic musical instrument to the control device 10 on the basis of the understood intention. The server device 30 generates voice data indicating the result of processing on the basis of data transmitted from the control device 10 and returns the generated voice data to the voice input and output device 40.

A voice recognition means 3011 of the server device 30 performs a process of recognizing voice data transmitted from the voice input and output device 40 and understands an intention of an utterance of a user (which is hereinafter referred to as a user utterance. The content of the user utterance is referred to as “user utterance text”). For example, it is assumed that a user has uttered “set a tempo to 120.” In this case, an intention indicating that “set a value <120>” to a parameter “tempo” is understood. Recognition of vocal sound and understanding of an intention can be performed using existing techniques. For example, the content of a user utterance may be converted to information indicating “what” and “how” using a model which has been subjected to machine learning in advance.

The voice recognition means 3011 may understand an intention of a subjective expression on the basis of information set in advance and convert the intention to a numerical value. For example, when “slightly set the tempo down” has been uttered and information indicating “slight (a little) in tempo is 3 BPM” is stored in advance, an intention indicating that “the parameter of tempo is set down by a value <3>” can be understood. When “slightly set reverb up” has been uttered and information indicating “slight (a little) in reverb is 3 dB” is stored in advance, an intention indicating that “the parameter of reverb is set down by a value <3>” can be understood. When “slightly set high of the equalizer down” has been uttered and information indicating “the high represents 12 kHz” and “slight (a little) in the equalizer is 3 dB” is stored in advance, an intention indicating that “the parameter of 12 kHz of the equalizer is set down by a value <3>” can be understood.

In addition, information indicating what genre of music an expression such as a “light piece of music” or a “calm piece of music” represents may be stored in advance and be used.

A conversion means 3012 converts an intention output from the voice recognition means 3011 to data in a format which can be understood by the control device 10 and converts a response transmitted from the control device 10 to voice data.

Data described in a general-purpose data exchange format is transmitted and received between the server device 30 and the control device 10. In this embodiment, data is exchanged using a communication protocol HTTPS or MQTT using data in the form of JavaScript Object Notation (JSON) (hereinafter referred to as JSON data). When MQTT is used as the protocol, data in an arbitrary format (for example, JSON, XML, Enciphered Binary, or Base 64) can be stored in the payload.

The functional blocks of the control device 10 will be described below.

The electronic musical instrument 20 to be controlled is not based on the premise of control using vocal sound, and thus does not include a voice interface. The control device 10 converts data transmitted from the server device 30 (JSON data generated on the basis of a user utterance) and data based on an interface of the electronic musical instrument 20 therebetween using a conversion means 1011. In this embodiment, the interface of the electronic musical instrument 20 is an MIDI interface and data based on the interface is an MIDI message.

The conversion means 1011 includes data for performing the aforementioned conversion (hereinafter referred to as conversion data) and performs the conversion with reference to the conversion data. Details of the conversion data will be described later.

The functional blocks of the electronic musical instrument 20 will be described below.

A control signal receiving means 2022 of the electronic musical instrument 20 is a means that receives an MIDI message converted by the control device 10 and processes the received MIDI message. A control signal transmitting means 2021 is a means that generates a response corresponding to the received MIDI message and transmits the generated response.

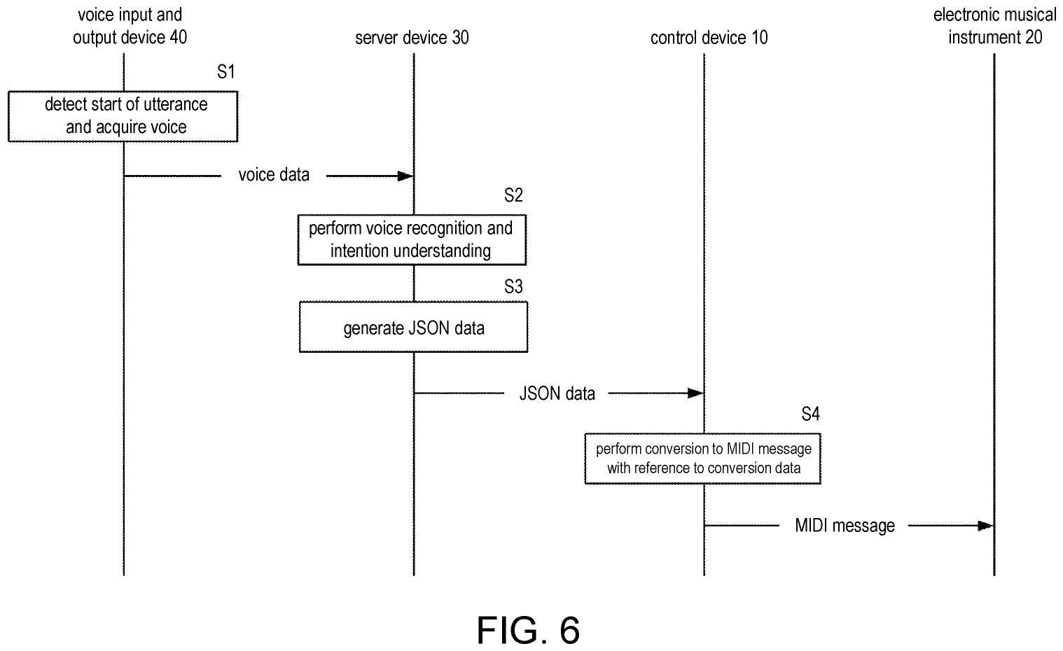

Processes until a corresponding MIDI message is transmitted to the electronic musical instrument 20 after a user has uttered vocal sound will be described below. FIG. 6 is a flowchart illustrating processes which are performed by the devices and data which is transmitted and received between the devices.

First, when a user uttered vocal sound to the voice input and output device 40, the voice input means 4011 detects the voice and acquires content of the user utterance (Step S1). For example, the voice input means 4011 detects a word for returning from a standby state (a wake word) and acquires the content of a subsequent utterance. The acquired user utterance text is converted to voice data and the voice data is transmitted to the server device 30 via the network.

The server device 30 (the voice recognition means 3011) acquiring the voice data performs voice recognition and converts the content of the user utterance to natural language text. An intention of the text is understood on the basis of a service set in advance (Step S2).

For example, when a user utterance is “set the tempo to 100,” understanding of an intention is performed on the result of recognition of the user utterance and the intention indicating that “the “tempo” is “set” to “100”” is understood. This service is realized using known technique and is set up in advance by a user.

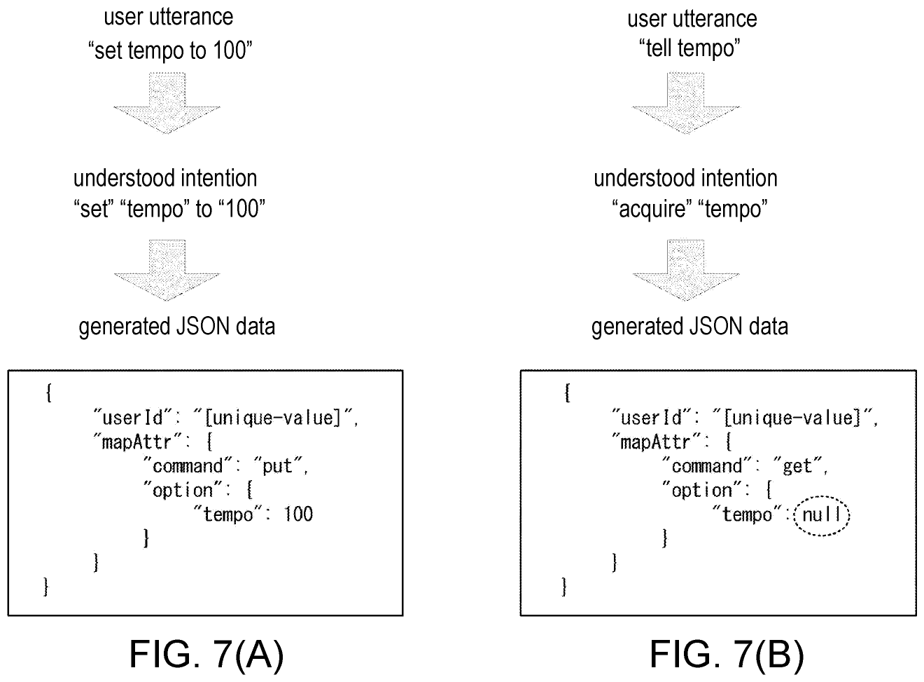

Then, the conversion means 3012 generates JSON data on the basis of the acquired intention (Step S3). FIG. 7(A) illustrates an example of JSON data. In this example, a value “put” is correlated with a key “command” and an object ““tempo”:100” is correlated with a key “option.” Accordingly, ““command”:“put”” means that the parameter of the electronic musical instrument 20 is set to a value. ““option”:{“tempo”:100}” means that the tempo is set to a value of 100. The JSON data is data obtained by converting a user's intention indicating that “the “tempo” is “set” to “100”” to a format which can be understood by the control device 10.

Then, the control device 10 (the conversion means 1011) converts the received JSON data to an MIDI message (Step S4).

This conversion is performed with reference to conversion data stored in advance.

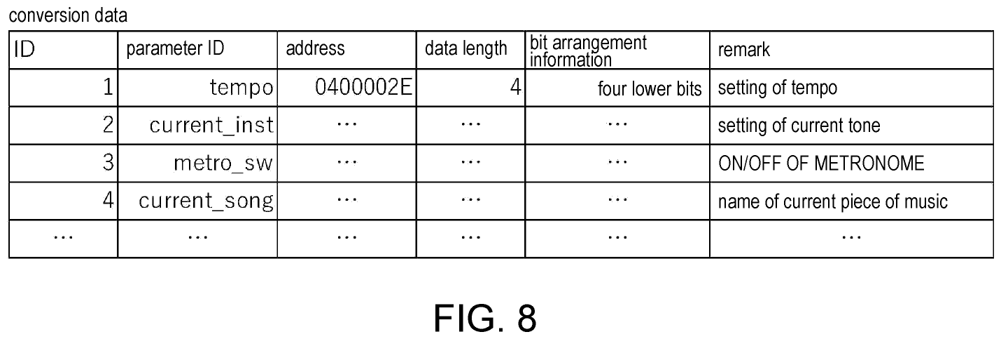

A conversion method will be described below. FIG. 8 illustrates an example of conversion data which is used by the control device 10. The data is stored in the auxiliary storage device 102 and is read according to necessity. In FIG. 8, the conversion data is illustrated in a table format, but is not limited to this format.

The conversion data is data in which a parameter ID described in the JSON data is correlated with an address, a data length, and bit arrangement information in the MIDI interface.

In this embodiment, when “command” described in the JSON data is “put,” a record in which the parameter ID (“tempo” herein) matches is identified and an address, a data length, and bit arrangement information are acquired. Then, an MIDI message for writing a value to be set (100 herein) to the acquired address is generated.

The data length and the bit arrangement information are used to generate data which is to be written to the electronic musical instrument 20. For example, when the value is 100 (0x64), the data length is 4 bytes, and the bit arrangement information indicates that “four lower bits are valid,” data which is to be written to the designated address is data obtained by extracting four lower bits (0x0064) out of data in which 0x64 is converted to a bit string of four bytes (00000000 00000000 00000011 00000010). It is possible to change the tempo by writing the generated data to the address corresponding to the tempo in the electronic musical instrument 20.

An MIDI message may be, for example, a message for writing data (also referred to as DT1), which is used for the MIDI standard.

When the conversion is completed, the conversion means 1011 transmits the generated MIDI message to the electronic musical instrument 20. Accordingly, the parameter (such as the tempo) is changed on the basis of the user utterance.

Although not illustrated in FIG. 6, the server device 30 (the conversion means 3012) may generate a response indicating that an instruction has been completed and transmit the response to the voice input and output device 40 at a timing at which the JSON data is transmitted to the control device 10. Accordingly, for example, since a response is output from the voice output means 4012, a user can see that the utterance has been processed by the system. The response may be natural language text or a sound effect.

As described above, with the electronic musical instrument system according to the first embodiment, it is possible to control an electronic musical instrument using vocal sound. Accordingly, it is possible to greatly improve convenience when a double-handed musical instrument such as a guitar or a drum is played. Without changing an interface or firm ware of an existing electronic musical instrument, the electronic musical instrument can be caused to cope with a voice command. An existing voice input and output device 40 and an existing server device 30 that provide an existing voice service can be used to control an electronic musical instrument.

In the first embodiment, an example in which the tempo is set has been described above, but other parameters may be set as long they are parameters which are used by the electronic musical instrument 20. For example, a current tone, a current sound volume, a type of an effect, or ON/OFF of a metronome function may be set.

### Second Embodiment

In the first embodiment, an example in which an arbitrary parameter is set for the electronic musical instrument 20 has been described above. In a second embodiment, parameters which are currently set for the electronic musical instrument 20 are inquired.

The hardware configuration and the functional configuration of an electronic musical instrument system according to the second embodiment are the same as in the first embodiment, thus description thereof will be omitted and only differences from the first embodiment will be described below. In the following description, steps which are not mentioned are the same as in the first embodiment.

In the second embodiment, a user gives a user utterance for inquiring about parameters such as “what tempo is set?” or “what is the current tempo?” By performing understanding of an intention on the user utterance, an intention indicating that “the “tempo” is “acquired”” is acquired in Step S2.

FIG. 7(B) illustrates an example of JSON data in this example. In this example, a value “get” is correlated with a key “command” and an object ““tempo”:null” is correlated with a key “option.” Accordingly, ““command”:“get”” means that a parameter of the electronic musical instrument 20 is read. ““option”:{“tempo”:null}” means that the parameter to be read is the tempo (an area in which the tempo is stored is null in the initial state). The JSON data is data obtained by converting a user's intention indicating that “the “tempo” is “acquired”” to a format which can be understood by the control device 10.

In Step S4, an MIDI message indicating that “a set tempo is inquired” is generated.

In this embodiment, when the command described in the JSON data is “get,” a record in which the parameter ID (“tempo” herein) matches is identified and an address, a data length, and bit arrangement information are acquired. Then, an MIDI message for reading a value from the acquired address is generated.

The method of generating the MIDI message is the same as in the first embodiment except that a message for requiring data is used instead of a message for writing data. The MIDI message may be, for example, a message (also referred to as RQ1) for requiring data, which his used in the MIDI standard.

When data is required, the second embodiment is the same as the first embodiment in that an address or a data length is designated and a message is generated.

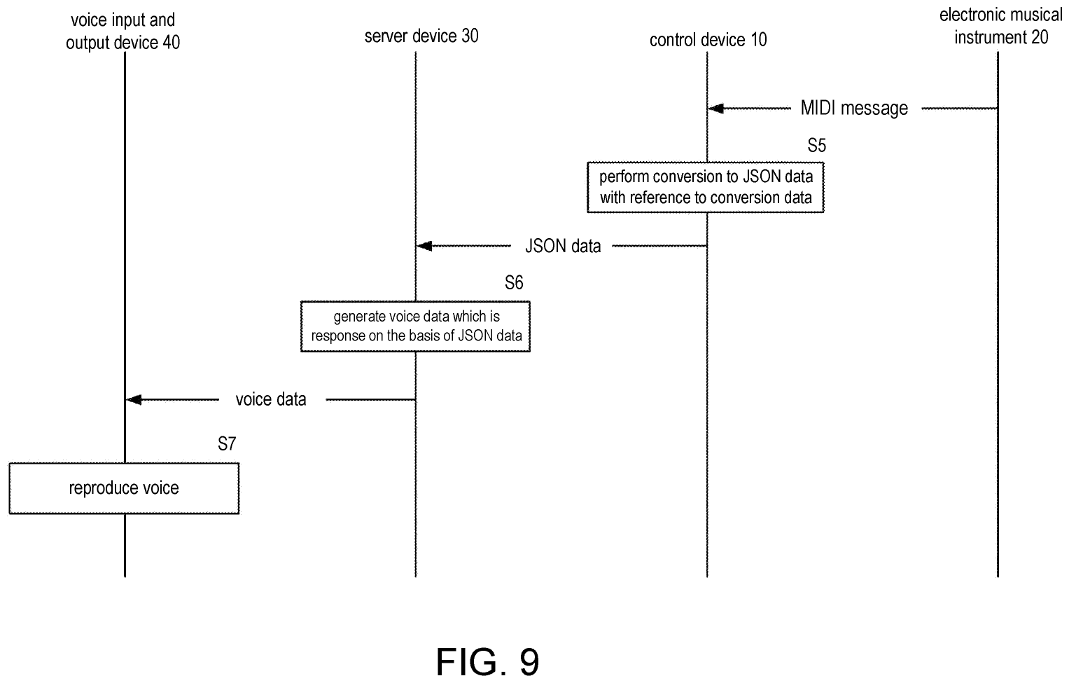

FIG. 9 is a diagram illustrating a flow of processes which are performed when a response is transmitted from the electronic musical instrument 20 in response to the MIDI message. Here, it is assumed that a response indicating that the set tempo is 120 is transmitted from the electronic musical instrument 20.

In Step S5, conversion from the MIDI message to the JSON message is performed. In this step, a value of the parameter stored in the designated address is acquired using the conversion data which is described above in the first embodiment.

The JSON data generated in this step is data in which the read value of the parameter is substituted into the dotted line part in FIG. 7(B). For example, when the read tempo is 120, an object ““tempo”:120” is generated. The data is transmitted to the server device 30.

Then, the server device 30 (the conversion means 3012) generates voice data which is provided to a user on the basis of the received JSON data (Step S6). Generation of voice data can be performed using existing techniques. For example, the conversion means 3012 generates voice data indicating that “the tempo is 120” on the basis of the received JSON data (which is an object ““tempo”:120” correlated with the key “option”).

The generated voice data is transmitted to the voice input and output device 40 (the voice output means 4012) and is output via the speaker (Step S7).

In this embodiment, an example in which a value of a parameter is read by vocal sound without any change is described above, but a numerical value may be replaced with a character string and transmitted to the server device 30 by the control device 10. For example, a numerical value indicating a tone may be replaced with a tone name to generate JSON data. This data may be a part of the aforementioned conversion data.

### Third Embodiment

In the first and second embodiments, it is assumed that a single electronic musical instrument 20 is connected to the control device 10. On the other hand, since an address of a parameter, a tone name, or the like is specific to an electronic musical instrument, it is difficult to connect a plurality of electronic musical instruments 20 to the control device 10 when a single piece of conversion data is used. In a third embodiment, connection of a plurality of electronic musical instruments 20 is enabled by automatically selecting conversion data.

The control device 10 according to the third embodiment stores a plurality of pieces of conversion data in the auxiliary storage device 102, and the control device 10 detects connection between the control device 10 and the electronic musical instrument 20 and selects conversion data corresponding to the connected electronic musical instrument 20 when the electronic musical instrument 20 is connected to the control device 10.

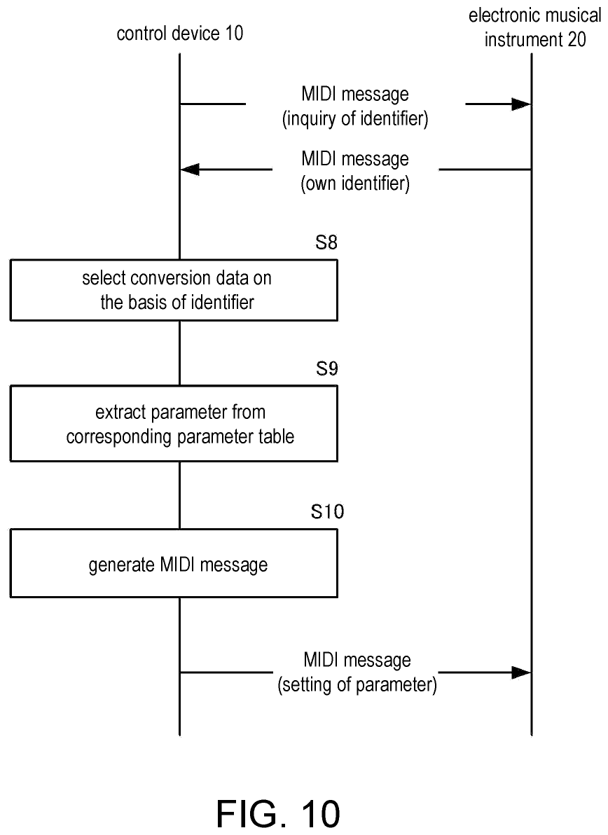

FIG. 10 is a diagram illustrating a flow of processes which are performed when an electronic musical instrument 20 is connected to the control device 10 in the third embodiment. When connection therebetween is completed, first, the control device 10 transmits an MIDI message for requiring an identifier to the electronic musical instrument 20 and the electronic musical instrument 20 transmits its own identifier to the control device 10 using an MIDI message. Then, the control device 10 (a conversion means 1011) selects conversion data which is correlated with the identifier out of a plurality of pieces of stored conversion data on the basis of the received identifier (Step S8).

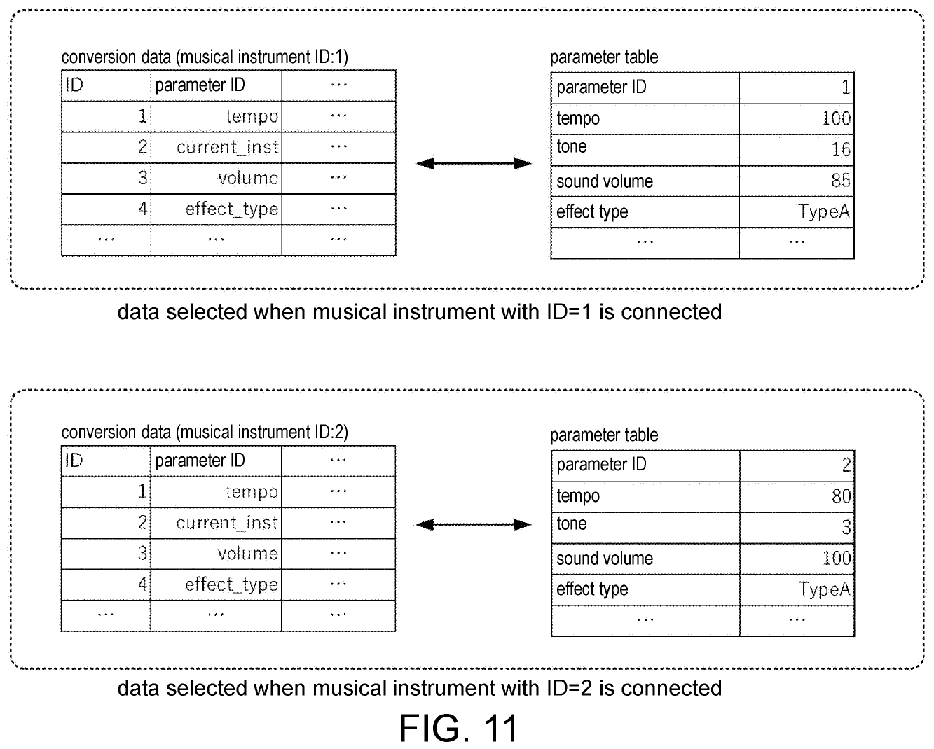

In the third embodiment, a parameter table specific to an electronic musical instrument is correlated with conversion data (see FIG. 11). The parameter table is a table in which a parameter which is to be set in the electronic musical instrument 20 at a timing at which the electronic musical instrument 20 is connected is described. In Step S9, the control device 10 extracts a plurality of parameters from the parameter table correlated with the selected conversion data.

Then, in Step S10, the control device 10 generates an MIDI message for setting the extracted parameters in the electronic musical instrument 20 and transmits the generated MIDI message.

In this way, by describing an arbitrary parameter in the parameter table, it is possible to set a predetermined parameter in the electronic musical instrument 20 at a timing at which the electronic musical instrument 20 is connected without uttering vocal sound. The parameter table may be prepared in advance and be dynamically updated.

In the aforementioned example, default parameters which are set in the electronic musical instrument 20 are described in the parameter table. On the other hand, details of the parameter table may be synchronized with details of the parameters set in the electronic musical instrument 20.

For example, at a timing at which the electronic musical instrument 20 is connected to the control device 10, the control device 10 may acquire all the parameters set in the electronic musical instrument 20 and record the acquired parameters in the parameter table. The parameter table may be updated using the parameters when the MIDI message for setting a parameter in the electronic musical instrument 20 is generated in Step S4. With this configuration, the control device 10 can normally ascertain a newest parameter which is set in the electronic musical instrument 20.

At the timing at which the electronic musical instrument 20 is connected to the control device 10, the control device 10 may transmit all the stored parameters to the electronic musical instrument 20 and set the parameters therein. With this method, it is also possible to synchronize the parameters set in the electronic musical instrument 20 with the parameters stored in the control device 10.

It is preferable to use a parameter table which differs depending on the types of the electronic musical instruments to be connected. Accordingly, even when a different type of electronic musical instrument is connected, parameters such as a sound volume can be set to appropriate values on the basis of characteristics of the electronic musical instrument.

### Fourth Embodiment

A fourth embodiment is an embodiment in which the control device 10 can store details of parameters of an electronic musical instrument which have been set immediately before and cancel settings (undo).

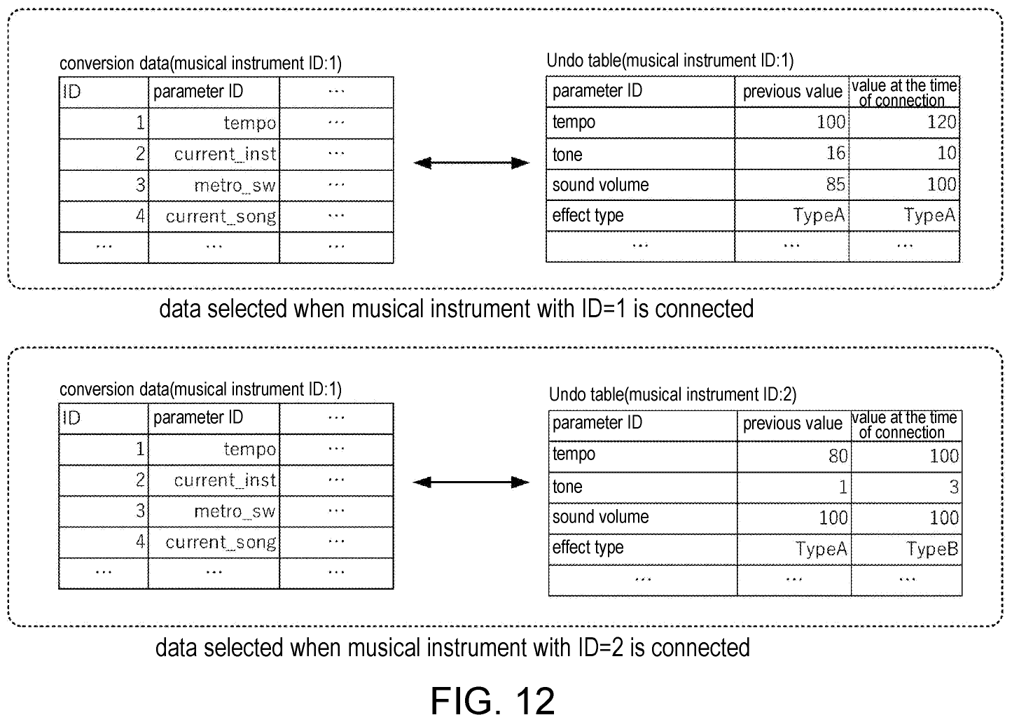

In the fourth embodiment, similarly to the third embodiment, the control device 10 stores a plurality of pieces of conversion data for each electronic musical instrument. Each of the plurality of pieces of conversion data is correlated with an undo table which is specific to an electronic musical instrument 20 (see FIG. 12). The undo table is a table in which parameters previously set in the electronic musical instrument 20 are described. As illustrated in FIG. 12, values of parameters which are immediately previous set and values of parameters which are set when an electronic musical instrument 20 is connected to the control device 10 are recorded in the undo table.

The undo table is updated at a timing immediately after an electronic musical instrument 20 is connected to the control device 10 and at a timing immediately before an MIDI message is transmitted to the electronic musical instrument 20. For example, when the tempo is changed from 100 to 120, information indicating tempo=100 is recorded as a previous value of the tempo. The previous value of the tempo may be acquired from the electronic musical instrument 20.

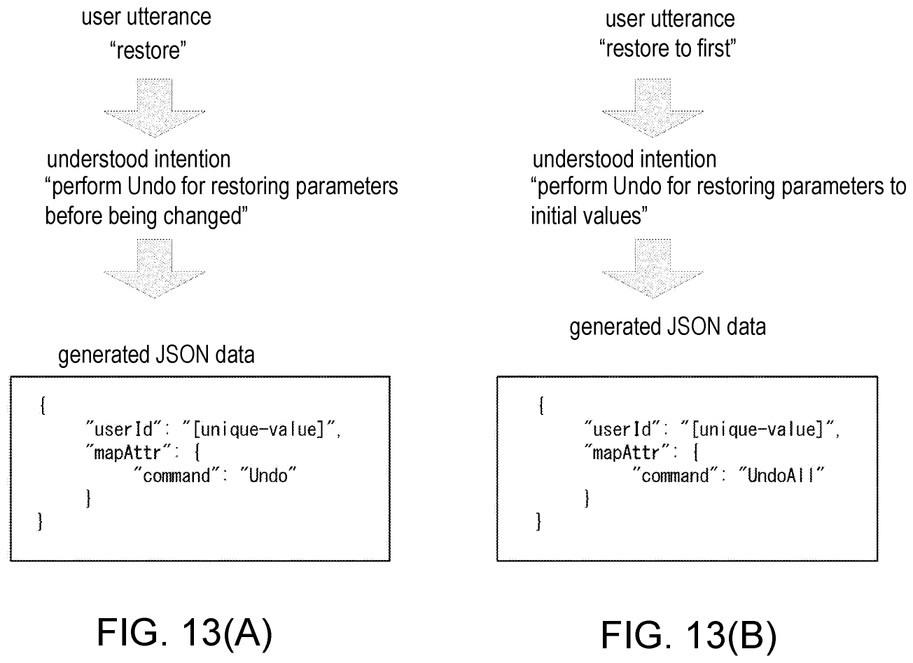

The undo table is used when a user utters vocal sound indicating that “changing of the parameters which was performed by a previous utterance is restored.” In this embodiment, two types including “undo for restoring the parameters to values before being changed” and “undo for restoring the parameters to initial values (values at the time of connection)” can be performed. For example, when a user utters “restore” as illustrated in FIG. 13(A), JSON data in which a command (“undo”) for restoring the parameters which was immediately previously changed is described is generated. When a user utters “restore to first” as illustrated in FIG. 13(B), JSON data in which a command (“UndoALL”) for restoring the parameters to initial values (values at the time of connection) is described is generated.

In this embodiment, when such a command is received, the control device 10 acquires parameters to be set with reference to the undo table, generates an MIDI message for setting the parameters in the electronic musical instrument 20, and transmits the MIDI message to the electronic musical instrument 20 in Step S4. Accordingly, the parameters changed by the user are restored to original values.

### MODIFIED EXAMPLES

The aforementioned embodiments are only examples and the disclosure can be appropriately modified without departing from the gist thereof. For example, the aforementioned embodiments may be combined.

In the aforementioned embodiments, a synthesizer is exemplified as the electronic musical instrument 20, but an electronic piano, electronic drums, an electronic wind instrument or the like may be connected.

A target to which a control signal is transmitted may not be an electronic musical instrument in which a sound source is incorporated. For example, a control signal may be transmitted to a device that adds an effect to an input voice (an effector) or a device that amplifies vocal sound (a musical instrument amplifier such as a guitar amplifier).

In the aforementioned embodiments, an electronic musical instrument that transmits and receives a message in the MIDI standard has been described, but a message in another standard may be used.

In the aforementioned embodiments, the JSON format is used for exchange of data between the control device 10 and the server device 30, but another format may be used.

When the server device 30 has a function of storing and caching information which are acquired in the past, a response may be generated using the stored information. For example, when a command indicating “set the tempo to 120” was transmitted to an electronic musical instrument in the past, the information may be cached by the conversion means 3012. When a user utters “what is the current tempo?” a response may be generated using the cached information.

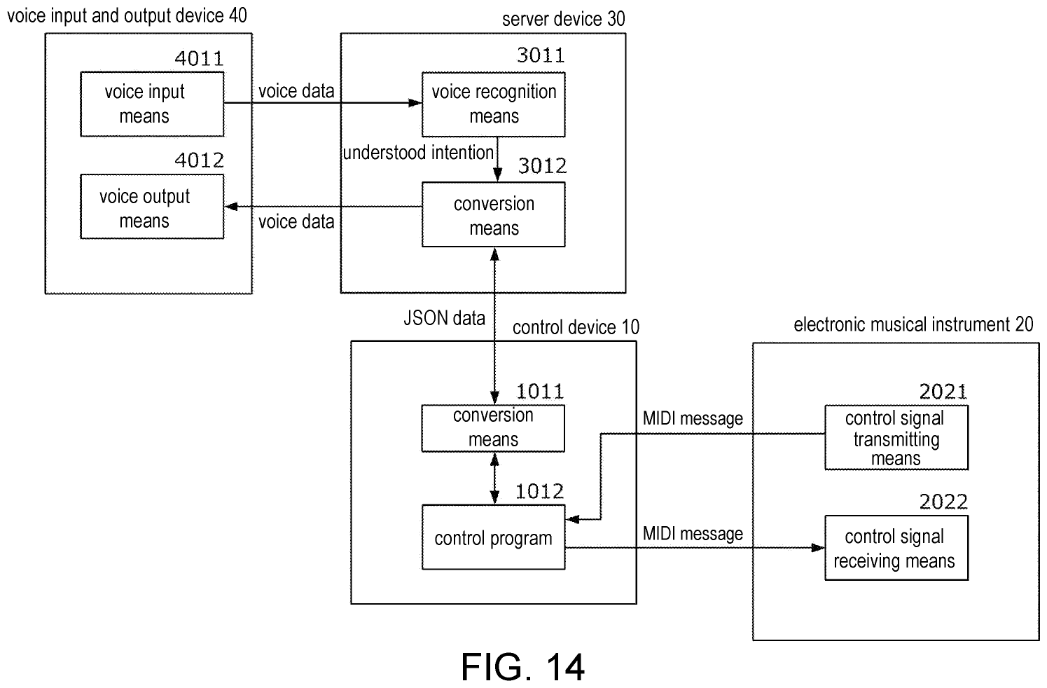

In the aforementioned embodiments, a single application is executed by the control device 10, but when there is an existing control program for controlling the electronic musical instrument 20, transmission and reception of an MIDI message may be performed via an API of the control program 1012 as illustrated in FIG. 14.

In the aforementioned embodiments, a single electronic musical instrument 20 is connected to the control device 10, but a plurality of electronic musical instruments 20 may be connected to the control device 10. In this case, an electronic musical instrument 20 that transmits and receives an MIDI message to and from the control device 10 may be designated. For example, when a user gives an utterance indicating that a musical instrument is changed (for example, “switch to Drum A”), the server device 30 may generate JSON data in which data indicating that the electronic musical instrument 20 is switched is described and transmit the JSON data to the control device 10.

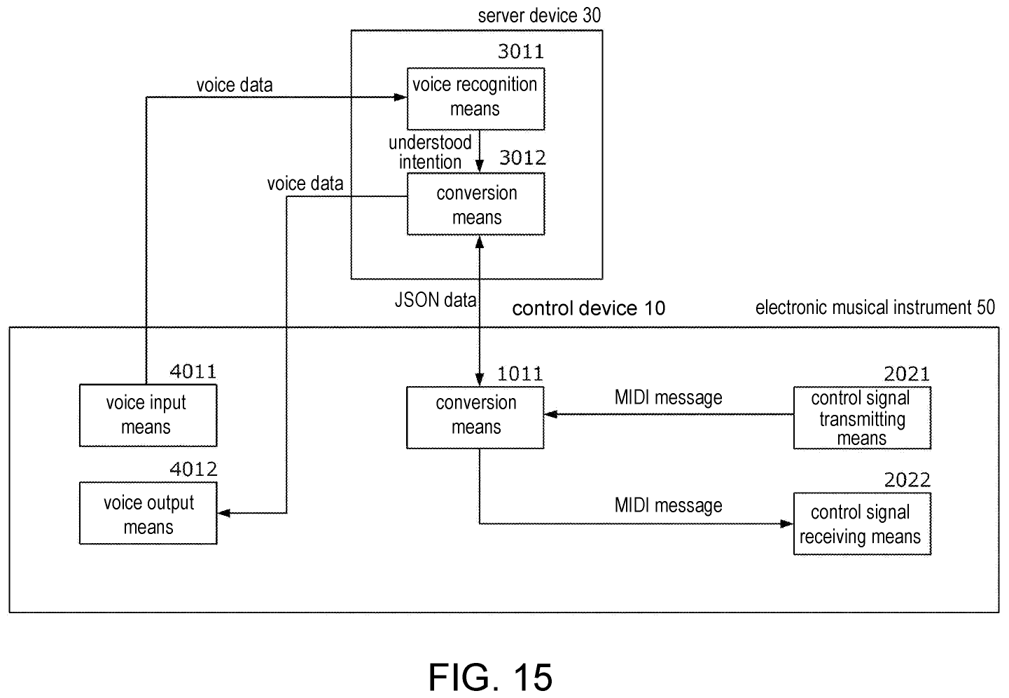

In the aforementioned embodiments, the control device 10, the electronic musical instrument 20, and the voice input and output device 40 are independent from each other, but these devices may be unified. For example, as illustrated in FIG. 15, an electronic musical instrument system including an electronic musical instrument 50 into which the devices are unified and a server device 30 may be employed.

### REFERENCE SIGNS LIST

10: Control device
20: Electronic musical instrument
30: Sever device
40: Voice input and output device

1. A control device that controls an electronic musical instrument, comprising:
an acquisition means that acquires first data which is generated in response to an utterance of a user from a dialogue engine which understands an intention of the utterance on a basis of the utterance and generates the first data in which the intention is stated;
a storage means that stores conversion data which is data in which the first data is correlated with a control command for controlling the electronic musical instrument; and
a conversion means that generates second data which is suitable for a control interface of the electronic musical instrument to be controlled on a basis of the first data that has been acquired and the conversion data and transmits the second data to the electronic musical instrument.

2. The control device according to claim 1, wherein the conversion means generates the second data comprising one of a command for changing a parameter set in the electronic musical instrument to be controlled and a command for reading the parameter that has been set on a basis of the first data.

3. The control device according to claim 1, wherein the conversion means acquires a response from the electronic musical instrument in response to the second data, converts the response to third data for causing the dialogue engine to generate a response utterance, and transmits the third data to the dialogue engine.

4. The control device according to claim 1, wherein the storage means stores the conversion data for each of a plurality of electronic musical instruments, and
wherein the conversion means selects a corresponding conversion data when it is detected that one of the plurality of electronic musical instruments has been connected to the control device.

5. The control device according to claim 1, wherein the storage means stores a history of a parameter set in a past in the electronic musical instrument on a basis of the second data, and
wherein the conversion means generates the second data for restoring the parameter with reference to the history when an intention indicating that the parameter set in the electronic musical instrument to be controlled is restored is stated in the first data that has been acquired.

6. An electronic musical instrument system comprising:
an electronic musical instrument that comprises a predetermined interface;
a voice input means that transmits vocal sound uttered by a user to a dialogue engine which understands an intention of an utterance of the user on a basis of the utterance and generates first data in which the intention is stated;
an acquisition means that acquires the first data generated in response to the utterance from the dialogue engine;
a storage means that stores conversion data in which the first data is correlated with a control command for controlling the electronic musical instrument; and
a conversion means that generates second data which is suitable for the predetermined interface on a basis of the first data that has been acquired and the conversion data and transmits the second data to the electronic musical instrument.

7. A control method which is performed by a control device that controls an electronic musical instrument, the control method comprising:
an acquisition step of acquiring first data which is generated in response to an utterance of a user from a dialogue engine which understands an intention of the utterance on a basis of the utterance and generates the first data in which the intention is stated; and
a conversion step of generating second data which is suitable for a control interface of the electronic musical instrument to be controlled on a basis of conversion data which is data in which the first data is correlated with a control command for controlling the electronic musical instrument and the first data that has been acquired and transmits the second data to the electronic musical instrument.

8. A non-transitory computer readable medium storing a program for causing a computer to perform the control method according to claim 7.

9. A control method which is performed by a control device that controls an electronic musical instrument, the control method comprising:
a step of acquiring and storing a parameter which is set in the electronic musical instrument when the electronic musical instrument has been connected to the control device;
a step of acquiring an instruction for changing at least a parameter of the electronic musical instrument from a user;
a step of generating a control command for changing the parameter that has been instructed on a basis of the instruction and transmitting the control command to the electronic musical instrument; and
a step of updating the parameter that has been stored with a changed parameter.

10. The control device according to claim 1, wherein understanding the intention of the utter means understanding a subjective expression of the utter on a basis of information set in advance in the storage means.

11. The electronic musical instrument system according to claim 6, wherein the second data comprising one of a command for changing a parameter set in the electronic musical instrument to be controlled and a command for reading the parameter that has been set on a basis of the first data.

12. The electronic musical instrument system according to claim 6, wherein the conversion means acquires a response from the electronic musical instrument in response to the second data, converts the response to third data for causing the dialogue engine to generate a response utterance, and transmits the third data to the dialogue engine.

13. The electronic musical instrument system according to claim 6, wherein the storage means stores the conversion data for each of a plurality of electronic musical instruments, and
wherein the conversion means selects a corresponding conversion data when it is detected that one of the plurality of electronic musical instruments has been connected to the conversion means.

14. The electronic musical instrument system according to claim 6, wherein the storage means stores a history of a parameter set in a past in the electronic musical instrument on a basis of the second data, and
wherein the conversion means generates the second data for restoring the parameter with reference to the history when an intention indicating that the parameter set in the electronic musical instrument to be controlled is restored is stated in the first data that has been acquired.

15. The electronic musical instrument system according to claim 6, wherein understanding the intention of the utter means understanding a subjective expression of the utter on a basis of information set in advance in the storage means.

16. The control method according to claim 7, wherein the second data comprising one of a command for changing a parameter set in the electronic musical instrument to be controlled and a command for reading the parameter that has been set on a basis of the first data.

17. The control method according to claim 7, wherein the conversion means acquires a response from the electronic musical instrument in response to the second data, converts the response to third data for causing the dialogue engine to generate a response utterance, and transmits the third data to the dialogue engine.

18. The control method according to claim 7, wherein the storage means stores the conversion data for each of a plurality of electronic musical instruments, and
wherein the conversion means selects a corresponding conversion data when it is detected that one of the plurality of electronic musical instruments has been connected to the control device.

19. The control method according to claim 7, wherein the storage means stores a history of a parameter set in a past in the electronic musical instrument on a basis of the second data, and
wherein the conversion means generates the second data for restoring the parameter with reference to the history when an intention indicating that the parameter set in the electronic musical instrument to be controlled is restored is stated in the first data that has been acquired.

20. The control method according to claim 7, wherein understanding the intention of the utter means understanding a subjective expression of the utter on a basis of information set in advance the acquisition step.
